(19) United States
(12) Patent Application Publication
(10) Pub. No.: US 2003/0233231 A1
(43) Pub. Date: Dec. 18, 2003

(54) Apparatus and method for managing privacy using voice recognition and caller identification

(75) Inventors: Craig William Fellenstein, Brookfield, CT (US); Carl Phillip Gusler, Austin, TX (US); Rick Allen Hamilton II, Charlottesville, VA (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/171,689

(22) Filed: Jun. 13, 2002

(51) Int. Cl. G10L 15/00

(52) U.S. Cl. 704/246

(57) ABSTRACT

An apparatus and method for managing privacy using voice recognition and caller identification information are provided. If a calling party calls from a location that does not have caller id information associated with it, or such caller id information is blocked, the calling party may record his/her voice identification with a privacy management service provider. The called party may then listen to the voice recording and decide whether to accept or reject the call. The voice print, or voice pattern, of the voice recording and the acceptance or rejection of the call may be stored in a storage device for later use in determining calls. At a later time, when the calling party again calls from his/her unidentifiable location, the calling party may again identify him/herself with a voice recording. The voice print from the voice recording may be extracted and compared to a library of voice prints for the called party. If the voice print matches a stored voice print, the corresponding identification of whether to accept or reject the call is retrieved. If the identification indicates acceptance of the call, the call is routed to the called party's telephone unit.

### BACKGROUND OF THE INVENTION

1. Technical Field

The present invention is directed to an apparatus and method for managing privacy using voice recognition and caller identification.

2. Description of Related Art

A relatively staple service for telephone service providers is caller identification, or caller id. Caller id allows a subscriber to obtain the identity and telephone number of a calling party through a caller id display located either in the telephone unit or a separate caller id unit before the call is answered. Later, telephone companies began to offer the service of blocking anonymous calls, i.e. calls for which caller id information was not available or blocked, to the home. That is, if a call to a called party were initiated and the called party has anonymous call blocking enabled, and that call had no caller id information available, then the call would not be routed to the telephone unit of the called party.

A fundamental problem, however, stopped many people from taking advantage of the anonymous call blocking service. If, for example, a resident of the home were in a third-party location and tried to call home, that person could find themselves unable to reach his or her family due to the fact that the phone of origin does not have corresponding caller id information. Thus, for fear of not being able to contact one's family in times of emergency, many people chose not to take advantage of anonymous call blocking services.

As a work-around to this problem, if a call is placed from a location which does not have caller id information, the caller has the option of recording his or her name for announcement to the called party. The service provider may then originate a separate call to the called party and indicate that a call has been received for them. The called party then has the option of listening to this recording and either answering or not answering the call based on the identification of the caller in the recording. If the call is answered, the service provider patches the original call through to the called party's telephone unit.

This work-around provides an improved operation of the anonymous call blocking service, but still further improvement is required. With this work-around, if a calling party does not have caller id information associated with their telephone unit, or if the calling party is out of a service area, the calling party must record his/her identification with each call placed to the called party that has anonymous call blocking enabled. The called party must then listen to the recording each time and indicate acceptance of the telephone call.

In addition, a calling party may give a false identification in order to dupe the called party into accepting a call. There is no mechanism for confirming the identity of the calling party. Thus, it would be beneficial to have an apparatus and method for managing privacy of a called party using voice recognition and caller identification information.

### SUMMARY OF THE INVENTION

The present invention provides an apparatus and method for managing privacy using voice recognition and caller identification information. With the present invention, if a calling party calls from a location that does not have caller id information associated with it, or such caller id information is blocked, the calling party may record his/her voice identification with a privacy management service provider. The called party may then listen to the voice recording and decide whether to accept or reject the call. The voice print, or voice pattern, of the voice recording and the acceptance or rejection of the call may be stored in a storage device for later use in determining calls.

At a later time, when the calling party again calls from his/her unidentifiable location, the calling party may again identify him/herself with a voice recording. The voice print from the voice recording may be extracted and compared to a library of voice patterns for the called party. If the voice print matches a stored voice print, the corresponding identification of whether to accept or reject the call is retrieved. If the identification indicates acceptance of the call, the call is routed to the called party's telephone unit. If the identification identifies that the call should be rejected, a recorded message may be returned to the calling party indicating that the calling party is not accepting the call.

Speech recognition may further be provided to determine a textual representation of the voice recording identification of the calling party. In this way, the caller id display of the called party's telephone unit or associated caller id device may be provided with a textual display of the voice recorded identification. Moreover, this textual representation may be stored along with the voice print to eliminate the need to perform speech recognition with each subsequent call from the calling party.

An editing function is provided via the service provider such that a called party may modify the called party's database of voice recorded calling parties to correct information or to add entries to the database. The called party may add textual representations of calling party identifications that are acceptable or rejectable such that when a calling party having the corresponding textual representation places a call to the called party, appropriate acceptance or rejection of the call is performed.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of an intelligent telephone network in accordance with the present invention;

FIG. 2 is an exemplary block diagram of a service provider according to the present invention;

FIG. 3 is message flow diagram illustrating the interaction between the calling party, service provider and called party during the placement of a call; and

FIG. 4 is a flowchart outlining an exemplary operation of the present invention.

### DETAILED DESCRIPTION OF THE PREFERRED EMBODIMENT

The present invention provides a mechanism for providing improved screening of calls for which caller identification information is not available. The present invention may be implemented, for example, in an intelligent telephone network having one or more service providers. The present invention may also be implemented in an Internet telephony system or a combination of telephone network and distributed computing system, as discussed hereafter.

FIG. 1 is an exemplary block diagram illustrating an intelligent telephone network in which the present invention may be implemented. An intelligent telephone network 110 is a telephone network having a backbone of computing devices used to route calls and provide subscriber services. Coupled to the intelligent telephone network 110 are a plurality of telephone terminals 120-140. The telephone terminals 120-140 may be any type of known or later developed telephone terminal including land-line telephone units, such as conventional telephones, and wireless telephone units, such as cellular, spread spectrum, PCS, and other types of wireless telephone units. Moreover, the telephone terminals 120-140 may be more sophisticated units such as integrated wireless telephones with personal digital assistants, Internet telephony devices, and the like. Any device capable of transmitting and receiving voice communication is intended to be within the spirit and scope of the present invention.

The telephone terminals 120-140 are coupled to the intelligent telephone network 110 via routing devices 180-195 and service providers 150-170. The routing devices 180-195 may take many forms depending on the type of telephone terminals 120-140 being used. For example, for conventional land-line telephones, a public switch 180, 195 may be utilized. For wireless telephone terminals, a base station 190 may be utilized for transmitting a wireless communication signal to the wireless telephone terminal.

Service providers 150-170 provide various telephone call related services to subscribers of these services. For example, a service provider 150 may provide caller ID services, call waiting services, call forwarding services, and the like, based on whether or not a particular owner of a telephone terminal 120 subscribes to one or more of these services. In a preferred embodiment, it is these service providers 150-170 that provide the services and functionality of the present invention.

The service providers 150-170 have associated subscriber database 155, 165 and 175 for storing information about subscribers and the services to which they subscribe. When a call is received by the service provider 150 for a subscriber telephone terminal 120, the service provider 150 performs a lookup in the subscriber database 155 to determine which services, if any, are to be provided to the subscriber telephone terminal 120. The service provider 150 then performs the necessary processing of the call to provide the services subscribed to by the owner of the telephone terminal 120.

It should be appreciated that the configuration illustrated in FIG. 1 is only intended for exemplary purposes and is not intended to imply any limitations on the present invention. For example, while a plurality of service providers 150-170 and subscriber databases 155-175 are illustrated in FIG. 1, the present invention may be implemented using a single service provider and/or single subscriber database. Other modifications to the intelligent telephone network configuration shown in FIG. 1 may be made without departing from the spirit and scope of the present invention.

In addition, it should be appreciated that the present invention is not limited to intelligent telephone networks. For example, the services and functionality of the present invention may be implemented in a distributed computing environment, such as the Internet. The telephone terminals 120-140 may be data network telephony devices that convert voice signals into data which is then transmitted over a data network and converted back into voice signals which are output at the called party telephone terminal. In such an environment, the functionality of the present invention may be provided by a server device or the like, that receives the telephony data and operates on that telephony data to perform the functions of the present invention.

As discussed above, the present invention provides an improved mechanism for managing privacy of a called party by using voice recognition and caller identification information. With the present invention, when a caller initiates a call to a called party telephone terminal, such as terminal 120, from the caller telephone terminal, such as terminal 130, the call is routed to, or otherwise operated on by, service provider 150. The service provider 150 extracts the identification of the called party telephone terminal 120, e.g., the telephone number, from the call header information and performs a lookup in the subscriber database 155 to determine which services, if any, the owner of the called party telephone terminal 120 subscribes to.

If the called party subscribes to the services of the present invention, the service provider 150 determines if caller identification information is available for the calling party. By caller identification information, what is meant is the identity of the owner of the calling party telephone terminal 130. Determining whether such caller identification information is available or not may include, for example, determining if the call header information includes caller identification information. Alternatively, this determination may involve a lookup of the calling party telephone terminal 130 telephone number or the like, in a central database to determine if there is corresponding caller identification information.

If caller identification information is available for the calling party, the telephone call is routed to the called party telephone terminal 120 in a normal fashion. This may involve outputting the caller identification information on a display of the called party telephone terminal 120 or associated caller ID unit.

If caller identification information is not available, e.g., the calling party has blocked the transmission of their caller identification information, then the service provider 150 may request that the calling party provide voice identification. The service provider 150 may return a prerecorded message, or the like, to the calling party telephone terminal 130 asking that the calling party speak their name into the receiver of the calling party telephone terminal 130.

The calling party's voice identification is recorded by the service provider 150 and converted into a voice print. The voice print is then compared to a list of voice prints stored in the subscriber database 155 associated with the called party telephone terminal 120. The service provider 150 then determines if a matching voice print is found in the subscriber database 155. If a matching voice print is found, a corresponding indicator as to whether to accept or reject the call from the calling party is retrieved. If the indicator states that the call should be accepted, the call is routed to the called party telephone terminal 120 and conventional telephone communication may take place. If the indicator states that the call should be rejected, a prerecorded message, or the like, may be returned to the calling party telephone terminal 130 indicating that the call has been rejected.

If a matching voice print is not found in the subscriber database 155, the service provider 150 may transmit a prerecorded message, or the like, to the called party telephone terminal 120 indicating that a call has been received and the voice identification may be output to the called party telephone terminal 120 for review by the called party. For example, the service provider 150 may output a prerecorded message stating, “You have received a call from.” and then the voice recording may be output, e.g., “Rick Hamilton.”

The called party may then decide to either accept or reject the call, e.g., by pressing an appropriate key on the telephone terminal 120. The called party's decision is then stored along with the voice print for the voice identification in the subscriber database 155 for later use in providing the above services. If the called party accepts the call, the call is then routed to the called party telephone terminal 120 where normal communication may take place. If the called party rejects the call, a prerecorded message indicating rejection of the call may be returned to the called party telephone terminal 130.

Thus, the present invention provides an improvement over known announcement-type systems in that voice prints are matched to not only verify the identity of the calling party but also to provide automation with regard to acceptance or rejection of calls. With the known systems, there is no ability to store lists of voice prints for calling parties with identifiers indicating whether to accept calls or reject calls from those calling parties. Rather, the calling party must always provide his/her identity and the called party must always review the calling party's identity and decide whether to accept or reject the call.

As a further enhancement of the present invention, speech recognition may be provided in order to extract a textual representation of the voice identification. For example, if the called party speaks his identity as being “Rick Hamilton,” the speech recognition of the present invention will extract the textual representation of Rick Hamilton. This textual representation may then be used to verify the authenticity of the calling party's voice identification. That is, a double check of the calling party's identity is performed by looking up the textual representation of Rick Hamilton in the calling party list stored in the subscriber database 155 and also determining if there is a matching voice print in the calling party list.

For example, the service provider 150 may generate a voice print from the voice identification provided by the calling party and determine if there is a matching voice print in the subscriber database 155. If a match is found, the textual representation extracted using speech recognition may then be compared to a textual representation of the stored voice print. If there is a match of the textual representations, then the calling party is most likely the person he/she has identified him/herself to be. If there is not a match of both the textual representation and the voice print, the calling party may be an impostor and the call may be rejected. Similarly, the lookup may be based on the textual representation first, with the voice print matching being used as a second level of authentication of the identity of the calling party. The use of the textual representation as an additional level of authentication is especially useful for entries in the list of calling parties that have been made by the called party using the editor functions of the present invention, as discussed in further detail hereafter.

The textual representation obtained through speech recognition may further be used as caller identification information should the called party accept a call from the calling party. That is, since the present invention operates when there is no caller identification information available for the calling party, caller identification information will not be displayed on the called party telephone terminal 120. By using speech recognition, a textual representation of the calling party's voice identification may be displayed at the called party telephone terminal 120.

In addition to the above, the present invention may provide an editor functionality that allows the called party to edit the list of voice prints to change, add or delete entries in the list. Such changes, additions and deletions may be effectuated by calling a number associated with the service provider 150, being authenticated, and performing various editing operations through the manipulation of an interface associated with the called party telephone terminal 120, e.g., the keypad of the telephone terminal 120.

In adding entries to the list of voice prints, the called party obviously cannot provide the actual voice print of the calling parties being added. However, the called party may enter the names of those parties. Such new entries being entered by the called party may have a flag associated with them indicating that they have been entered by the called party. As a result, when one of these calling parties places a call to the called party, rather than rejecting the call because the voice print does not match, the service provider may accept the first call from a person claiming to be that calling party and store the voice print for that first caller in association with the called party's entry in the list. Thereafter, the service provider will perform the voice print matching for this calling party, as discussed above.

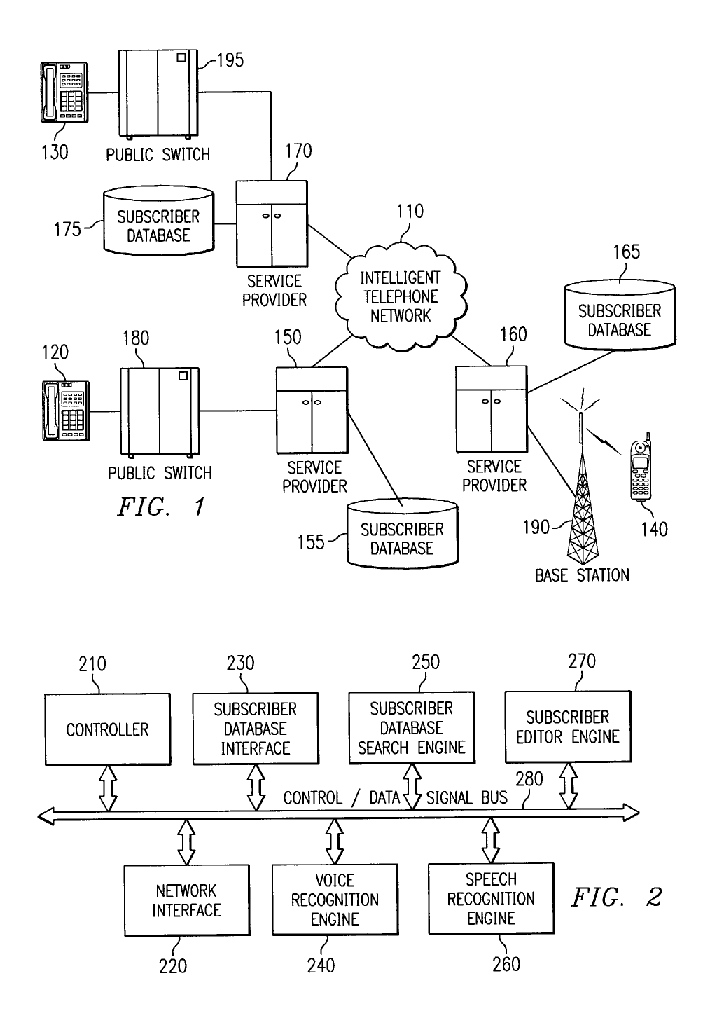

FIG. 2 is an exemplary block diagram of a service provider in accordance with the present invention. The elements shown in FIG. 2 may be implemented in hardware, software, or any combination of hardware and software without departing from the spirit and scope of the present invention. In a preferred embodiment, the elements shown in FIG. 2 are implemented as software instructions executed by hardware elements, such as processors, network devices, memories, and the like.

As shown in FIG. 2, the service provider includes a controller 210, a network interface 220, a subscriber database interface 230, a voice recognition engine 240, a subscriber database search engine 250, a speech recognition engine 260 and a subscriber editor engine 270. The elements 210-270 are coupled to one another via the control/data signal bus 280. Although a bus architecture is shown in FIG. 2, the present invention is not limited to such and any architecture that facilitates the communication of control/data signals between the elements 210-270 may be used without departing from the spirit and scope of the present invention.

The controller 210 controls the overall operation of the service provider and orchestrates the operation of the other elements 220-270. The controller 210 receives calls from, routes calls to, and transmits prerecorded messages to telephone terminals via the network interface 220. The controller 210 retrieves subscriber data from, and writes subscriber data to, the subscriber database via the subscriber database interface 230.

The voice recognition engine 240 performs the functions of obtaining a voice identification from a calling party, converting the voice identification to a voice pattern, and performing voice pattern matching using calling party list information retrieved from the subscriber database. The subscriber database search engine 250 performs the actual functions of searching the subscriber database for matching entries.

The speech recognition engine performs the functions of extracting a textual representation of the voice identification and performing a search of the calling party list retrieved from the subscriber database for a matching textual representation. The controller 210 may store the textual representation obtained using the speech recognition engine 240 in association with the voice print extracted by the voice recognition engine 240 and an indicator of acceptance or rejection of calls, in the calling party list of the subscriber database.

The subscriber editor engine 270 performs the functions associated with authenticating a called party and providing an interface through which the called party may edit the calling party list for the called party. The subscriber editor engine 270 provides the necessary interaction for adding, deleting and modifying entries in the calling party list associated with the called party, which is retrieved from the subscriber database via the subscriber database interface 230.

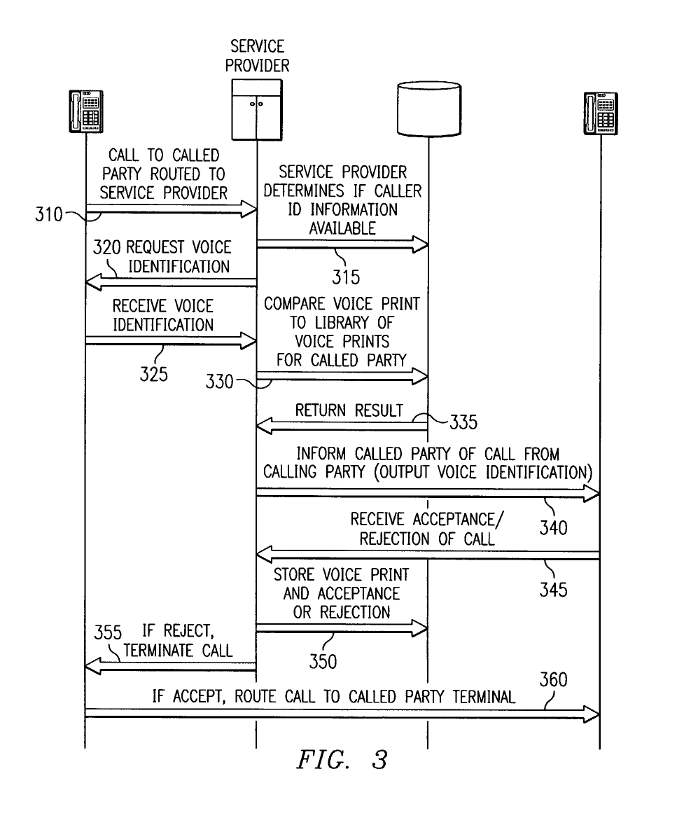

FIG. 3 is an exemplary message flow diagram illustrating an exemplary interaction according to the present invention. As shown in FIG. 3, a calling party places a call to a called party which is routed to the service provider (310). The service provider determines if caller identification information is available (315). If so, the message flow may jump to 360 where the call is routed to the called party telephone terminal (not shown). However, in the depicted message flow, it is assumed that caller identification information is not available for the calling party.

The service provider then requests voice identification from the calling party (320). The calling party provides the voice identification (325) which is stored by the service provider and used as a basis for generating a voice print. The voice print is compared to the library, or list of calling party voice prints, for the called party (330). A result is then returned as to whether a matching voice print is identified (335).

If a matching voice print is identified (not shown), the corresponding acceptance (360) or rejection (355) of the call is performed. If a matching voice print is not identified, the called party is informed of the call from the calling party and the voice identification is output for review by the called party (340). The called party's decision to accept or reject the call is then received (345). The called party's decision is stored in association with the voice print (350). If the decision was to reject the call, the call is terminated (355). IF the decision was to accept the call, the call is routed to the called party telephone terminal and normal communication is made possible (360).

As mentioned earlier, other features of the present invention include the ability to perform speech recognition to provide a second level of authentication and to provide caller identification information for display at the called party telephone terminal. These features are not explicitly shown in the message flow of FIG. 3 but may be included without departing from the spirit and scope of the present invention. For example, additional messaging may be provided after 330 for comparing textual representations. The informing of the called party of the call (340) may further include the displaying of the textual representation at the called party telephone terminal.

Thus, the present invention provides an automated mechanism for authenticating a calling party for which caller identification information is not available, and automatically determining whether to accept or reject calls from the calling party. The present invention alleviates the burden on the called party of having to review calling party voice identifications and decide whether to accept or reject the call.

The above embodiments have been described in terms of a calling party list of voice prints in which both acceptable and non-acceptable calling parties are listed. However, the present invention is not limited to such. Rather, the calling party list of voice prints may include only those calling parties for which calls will be accepted, or only those calling parties for which calls will be rejected. In so doing, a determination of whether to accept or reject a call may be based entirely on whether or not a matching voice print (and optionally a textual representation) is found in the calling party list of voice prints.

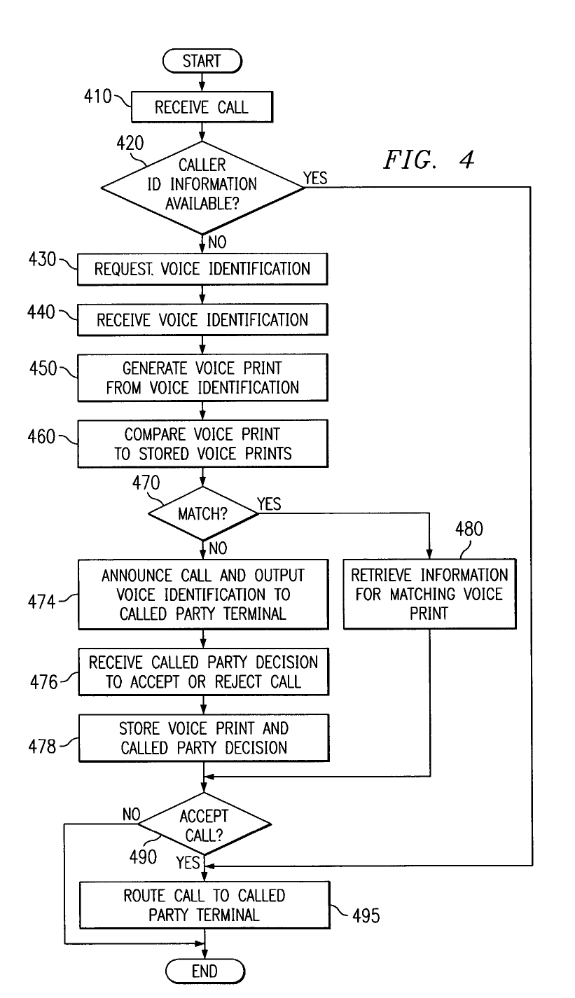

FIG. 4 is a flowchart outlining an exemplary operation of the present invention. As shown in FIG. 4, the operation starts with receipt of a call (step 410). A determination is made as to whether caller identification information is available for the calling party (step 420). If so, the call is routed to the called party telephone terminal and the caller identification information is displayed (step 495). If not, voice identification is requested (step 430).

The voice identification is received (step 440) and a voice print is generated from the voice identification (step 450). The generated voice print is then compared to the stored voice prints (step 460). A determination is made as to whether there is a match (step 470).

If there is a match, information is retrieved for the matching voice print (step 480) and a determination is made as to whether the call should be accepted (step 490). If the retrieved information indicates that the call should be accepted, the call is routed to the called party terminal (step 495). Otherwise, the call is rejected and the operation ends.

If there is not a matching voice print, the call is announced and the voice identification is output to the called party terminal for review by the called party (step 474). The decision whether to accept or reject the call is received from the called party (step 476). The decision is then stored along with the voice print in the calling party list of voice prints (step 478) and the operation proceeds to step 490 where it is determined whether to accept or reject the call. If the called party chose to accept the call, the call is routed to the called party terminal (step 495). Otherwise, the call is terminated.

Thus, the present invention provides an automated mechanism for managing privacy of called parties. The present invention preserves the privacy of called parties by automatically determining whether the called party wishes to accept calls from the calling party based on previous acceptance or rejection of calls. The present invention further provides a mechanism for authenticating the identity of the calling party by using voice pattern matching (and optionally textual representation matching). Thus, the present invention provides a more secure mechanism for preventing impostors from harassing or otherwise communicating with the called party.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of determining whether to accept a call from a calling party, comprising:
obtaining a voice print of the calling party;
comparing the voice print to a list of calling party voice prints; and
determining whether to accept or reject the call based on results of the comparison of the voice print to the list of calling party voice prints.

2. The method of claim 1, further comprising:
receiving a call from the calling party; and
determining if the call has associated caller identification information, wherein the steps of obtaining a voice print, comparing the voice print to a list of calling party voice prints, and determining whether to accept or reject the call are performed only if the call does not have associated caller identification information.

3. The method of claim 1, wherein if it is determined to reject the call, a recorded message is returned to the calling party.

4. The method of claim 1, further comprising:
performing speech recognition on the voice print to identify a textual representation of the voice print; and
outputting the textual representation to a destination of the call.

5. The method of claim 4, wherein the textual representation is output at the destination using a display device.

6. The method of claim 4, further comprising:
storing the textual representation in association with the voice print in the list of calling party voice prints.

7. The method of claim 4, further comprising:
determining if a matching voice print in the list of calling party voice prints has an associated textual representation, wherein the step of performing speech recognition is performed only if the matching voice print in the list of calling party voice prints does not have an associated textual representation.

8. The method of claim 1, wherein the list of calling party voice prints is stored in association with an identification of a called party.

9. The method of claim 8, further comprising:
providing a called party with an editor for editing the list of calling party voice prints stored in association with the identification of the called party.

10. The method of claim 1, wherein the determination to either accept or reject the call is based on an indicator stored in association with a matching voice print in the list of calling party voice prints.

11. The method of claim 1, wherein the determination to either accept or reject the call is based on a called party input received from a called party device if there is not a matching voice print in the list of calling party voice prints.

12. The method of claim 11, further comprising:
storing the voice print in association with an indicator of whether to accept or reject future calls, the indicator being set based on the called party input.

13. The method of claim 4, further comprising:
determining if a matching voice print in the list of calling party voice prints has an associated textual representation; and
comparing the textual representation of the voice print to the textual representation associated with the matching voice print if the matching voice print has an associated textual representation.

14. An apparatus for determining whether to accept a call from a calling party, comprising:
means for obtaining a voice print of the calling party;
means for comparing the voice print to a list of calling party voice prints; and
means for determining whether to accept or reject the call based on results of the comparison of the voice print to the list of calling party voice prints.

15. The apparatus of claim 14, further comprising:
means for receiving a call from the calling party; and
means for determining if the call has associated caller identification information, wherein the means for obtaining a voice print, means for comparing the voice print to a list of calling party voice prints, and means for determining whether to accept or reject the call operate only if the call does not have associated caller identification information.

16. The apparatus of claim 14, wherein if the means for determining whether to accept or reject the call determines to reject the call, a recorded message is returned to the calling party.

17. The apparatus of claim 14, further comprising:
means for performing speech recognition on the voice print to identify a textual representation of the voice print; and
means for outputting the textual representation to a destination of the call.

18. The apparatus of claim 17, further comprising:
means for storing the textual representation in association with the voice print in the list of calling party voice prints.

19. The apparatus of claim 17, further comprising:
means for determining if a matching voice print in the list of calling party voice prints has an associated textual representation, wherein the means for performing speech recognition operates only if the matching voice print in the list of calling party voice prints does not have an associated textual representation.

20. The apparatus of claim 14, wherein the list of calling party voice prints is stored in association with an identification of a called party.

21. The apparatus of claim 20, further comprising:
means for providing a called party with an editor for editing the list of calling party voice prints stored in association with the identification of the called party.

22. The apparatus of claim 14, wherein the means for determining whether to accept or reject the call determines whether to accept or reject the call based on an indicator stored in association with a matching voice print in the list of calling party voice prints.

23. The apparatus of claim 14, wherein the means for determining whether to accept or reject the call determines whether to accept or reject the call based on a called party input received from a called party device if there is not a matching voice print in the list of calling party voice prints.

24. The apparatus of claim 23, further comprising:
means for storing the voice print in association with an indicator of whether to accept or reject future calls, the indicator being set based on the called party input.

25. The apparatus of claim 17, further comprising:
means for determining if a matching voice print in the list of calling party voice prints has an associated textual representation; and
means for comparing the textual representation of the voice print to the textual representation associated with the matching voice print if the matching voice print has an associated textual representation.

26. A computer program product in a computer readable medium for determining whether to accept a call from a calling party, comprising:
first instructions for obtaining a voice print of the calling party;
second instructions for comparing the voice print to a list of calling party voice prints; and
third instructions for determining whether to accept or reject the call based on results of the comparison of the voice print to the list of calling party voice prints.

27. The computer program product of claim 26, further comprising:
fourth instructions for receiving a call from the calling party; and
fifth instructions for determining if the call has associated caller identification information, wherein the first instructions for obtaining a voice print, second instructions for comparing the voice print to a list of calling party voice prints, and third instructions for determining whether to accept or reject the call execute only if the call does not have associated caller identification information.

28. The computer program product of claim 26, further comprising:
fourth instructions for performing speech recognition on the voice print to identify a textual representation of the voice print; and
fifth instructions for outputting the textual representation to a destination of the call.

29. The computer program product of claim 28, further comprising:
sixth instructions for determining if a matching voice print in the list of calling party voice prints has an associated textual representation, wherein the fourth instructions for performing speech recognition execute only if the matching voice print in the list of calling party voice prints does not have an associated textual representation.

30. The computer program product of claim 28, further comprising:
sixth instructions for determining if a matching voice print in the list of calling party voice prints has an associated textual representation; and
seventh instructions for comparing the textual representation of the voice print to the textual representation associated with the matching voice print if the matching voice print has an associated textual representation.
